(19) United States
(12) Patent Application Publication
(10) Pub. No.: US 2013/0105056 A1
(43) Pub. Date: May 2, 2013

(54) TIRE HAVING MODULAR PLY CONSTRUCTION AND METHOD OF MAKING SAME

(71) Applicants: Joseph Kevin Hubbell, Akron, OH (US); Cynthia L. Nelson, Wadsworth, OH (US)

(72) Inventors: Joseph Kevin Hubbell, Akron, OH (US); Keith Carl Trares, Akron, OH (US); Robert B. Nelson, Wadsworth, OH (US)

(21) Appl. No.: 13/284,394

(22) Filed: Oct. 28, 2011

(51) Int. Cl. B60C 9/02; B29D 30/24; B29D 30/30; B60C 15/00

(52) U.S. Cl. 152/553; 156/117

(57) ABSTRACT

A pneumatic tire for use on a vehicle includes a pair of beads, a pair of opposing sidewalls, and a tread. Sidewall plies form portions of respective sidewalls. The plies extend around respective beads to form respective inside turn-ups. Central plies extend between and overlap the sidewall plies. The overlap of the plies forms overlap regions proximate respective shoulders sized to protect the tire from penetration by road debris during use of the tire. The tire may be belt-less. A tire set includes tires differing in section width and/or section height. At least one of the sidewall plies in the set is substantially the same width as the corresponding sidewall ply in another tire in the set. A method of making tires of different section width and/or section height includes using a source of plies used for supplying at least one of the plies in each tire in the set.

### TECHNICAL FIELD

The present invention generally concerns a pneumatic tire, and, more particularly, a pneumatic tire having a modular ply construction.

### BACKGROUND

Tires are complex composites. As such, they contain a multitude of materials which, during manufacturing, are often placed in layers and then bonded together. Of the layers and materials, a tire may contain a ply or a sheet of material that is itself a composite. The ply may contain cords of another material that are radially oriented with respect to the rotational axis of the tire, that is, nominally at about 90° with respect to the centerline of the tread. The ply often extends from one bead to an opposing bead of the tire.

Tires that contain cords that are oriented in this direction are referred to as “radial” tires. This is in contrast to what are known as “bias” type tires in which the cords of the plies criss-cross one another and are oriented at a transverse angle (e.g., around 30° to 40°) relative to the center line of the tread. Thus, the cords in a bias tire are generally oriented more in the direction of the tire's rotation than are the cords in radial tires.

It is well-established that radial tires are, in many respects, superior to bias-type tires. Typically, for example, a vehicle having radial tires rides better, radial tires have better wear and traction than bias type tires, and radial tires are more fuel efficient than bias tires. However, radial tires often require additional belts beneath the tread, generally made of steel, to reinforce the tread.

In this regard, it is common for manufacturers to use two belts to reinforce the tread. Each may be made of steel cords which may be oriented at bias angles relative to the rotational axis. The belts are generally stacked one on top of the other adjacent the ply and are usually offset at each edge to produce a step off. It is known that belts affect vehicle ride and handling characteristics by restricting expansion of the ply cords and stabilizing the tread area. Belts also provide impact and penetration resistance.

However, addition of a belt to a radial tire tread is not without its drawbacks. Aside from an increase in the manufacturing and raw materials costs, a belt increases the weight of the tire and therefore increases the fuel consumption of the vehicle to which it is affixed. Other potential drawbacks include an increase in the running temperature of a tire. The running temperature of a tire ultimately affects the tire's performance.

In view of the above, tire manufacturing is also a complex process that may include applying multiple layers of different materials to a building drum. Once the other components of the tire are placed on the building drum, the layered structure may then be shaped into a general toroidal form of a tire. This so-called “green tire” is cured and molded by application of heat and pressure to obtain the desired tire.

Each of the processes affects the tire's shape. Therefore, it is not surprising, in light of the large number of variables that must be addressed to consistently manufacture tires of like shape and size, that development of a new tire design is often subject to some trial-and-error-type testing. More specifically, among the various steps in the manufacturing process of a radial tire, a ply is placed onto the building drum. During the curing process, when the green tire is molded into its final shape, improper tension in the ply may lead to unacceptable shape variability. To address this issue, the tension in the ply may be adjusted by changing the ply length and the gage of the ply. While appearing simple, the magnitude of the adjustment is often approached in a trial-and-error fashion. Ultimately, the imprecise nature of these adjustments increases the cost and time required to develop a new tire design and bring it to market.

In view of the aforementioned difficulties, there remains a need for a radial tire with improved performance while being more cost effective to develop and manufacture.

### SUMMARY

In one embodiment, a pneumatic tire for use on a vehicle comprises a first bead and a second bead each configured to anchor the tire to a rim of the vehicle. The pneumatic tire includes a pair of opposing sidewalls forming opposing shoulders and extending radially inward from a tread. A first ply forms a portion of one sidewall. The first ply extends from one shoulder around the first bead from outside to inside, so as to form a first inside turn-up. A second ply, separate from the first ply and forming a portion of the opposing sidewall, extends from the opposing shoulder around the second bead from outside to inside, so as to form a second inside turn-up. A first central ply adjacent the tread extends between and overlaps the first ply and the second ply. A second central ply adjacent the tread and the first central ply extends between and overlaps the first ply and the second ply. The overlap of the first central ply with each of the first and second plies forms a first overlap region separated from a second overlap region, respectively. The first overlap region is proximate the one shoulder and the second overlap region is proximate the opposing shoulder, each of the first and second overlap regions are sized to protect the tire from penetration by road debris during use of the tire. In one embodiment, the pneumatic tire is belt-less.

In one embodiment, the cords of at least one of the first central ply and second central ply is at least one of carbon fibers, or aramid fibers, or combinations thereof.

In one embodiment, a tire set comprises a first tire having a first section width and a first section height, and a second tire having a second section width and a second height. At least one of the first section width and the first section height differs from the corresponding one of the second section width and the second section height. Each of the first tire and the second tire includes a pair of opposing sidewalls forming opposing shoulders and extending radially inward from a tread and a pair of beads configured to anchor the respective tire to a rim on a vehicle.

Each of the first tire and the second tire comprises a sidewall ply forming a portion of each sidewall of the pair of sidewalls and defining an inside turn-up at one edge thereof with an opposing edge extending to a location proximate the corresponding shoulder. A central ply is positioned adjacent each tread and extends between and overlaps the corresponding sidewall plies so as to form at least two overlap regions. One overlap region is proximate each shoulder of each tire. Each of the sidewall plies and the central ply in the first tire are substantially the same width as each of the corresponding sidewall plies and the corresponding central ply in the second tire. At least one of the overlap regions in the first tire is substantially different in dimension from one of the overlap regions in the second tire. The difference in dimension being related to the difference between the first section width and the second section width and/or the first section height and the second section height.

In another embodiment, a method of making tires of different section width and/or section height comprises manufacturing a first tire and manufacturing a second tire. Manufacturing the first tire comprises applying a first set of plies to a first building drum. One ply is configured to form portions of each of a pair of opposing sidewall plies and at least one ply is configured to be adjacent a tread in the first tire. The opposing sidewall plies do not overlap and are spaced apart from each other on the first building drum. The ply adjacent the tread extends between and overlaps each of the sidewall plies.

Manufacturing the second tire comprises applying a second set of plies to a second building drum. At least one of the plies of the second set of plies is from a source of plies used for supplying at least one of the plies of the first set of plies during manufacturing of the first tire. One ply of the second set of plies is configured to form a portion of each of a pair of opposing sidewall plies and at least one ply is configured to be adjacent a tread in the second tire. The opposing sidewall plies of the second set of plies do not overlap and are spaced apart from each other on the second building drum and the at least one ply extends between and overlaps each sidewall ply. The first tire differs in dimension from the second tire in at least one of section width or section height.

### DEFINITIONS

“Bead” means a circumferentially substantially inextensible metal wire assembly that forms the core of the bead area, and is associated with holding the tire to the rim.

“Ply” or “Plies” means a calendared fabric thread coated with rubber and wound around at least one bead.

“Carcass” means the tire structure apart from the belt structure, tread, undertread, and sidewall rubber over the plies, but including the beads.

“Green” means material, typically rubber, which has not undergone a curing or pre-curing process.

“Inner Liner” means a molded rubber layer covering the inner side of the carcass and facing the air chamber when the tire is assembled.

“Pneumatic Tire” means a laminated mechanical device of generally toroidal shape, usually an open torus, having beads and a tread and made of rubber, chemicals, fabric, and steel or other materials. When mounted on the wheel of a motor vehicle, the tire through its tread provides traction and contains the fluid that sustains the vehicle load.

“Sidewall” means that portion of a tire between the tread and the bead area.

“Tread” means a molded rubber component which includes the portion of the tire that comes into contact with the road when the tire is normally inflated and under normal load.

### BRIEF DESCRIPTION OF THE DRAWINGS

The invention will be described by way of example and with reference to the accompanying drawings in which:

FIG. 1 is a cross-sectional view of a tire according to one embodiment of the invention;

FIG. 2 is a cross-sectional view of a tire according to one embodiment of the invention having a narrower section width than the tire of FIG. 1;

FIG. 3A is a side elevation view of an arrangement of plies to be used in manufacturing a tire according to one embodiment of the invention;

FIG. 3B is a plan view of the arrangement of FIG. 3A;

FIG. 4A is a side elevation view of another arrangement of plies to be used in manufacturing a tire according to one embodiment of the invention;

FIG. 4B is a plan view of the arrangement of FIG. 4A; and

FIG. 5 is a diagrammatic representation of a method of manufacturing a set of tires according to one embodiment of the invention.

### DETAILED DESCRIPTION

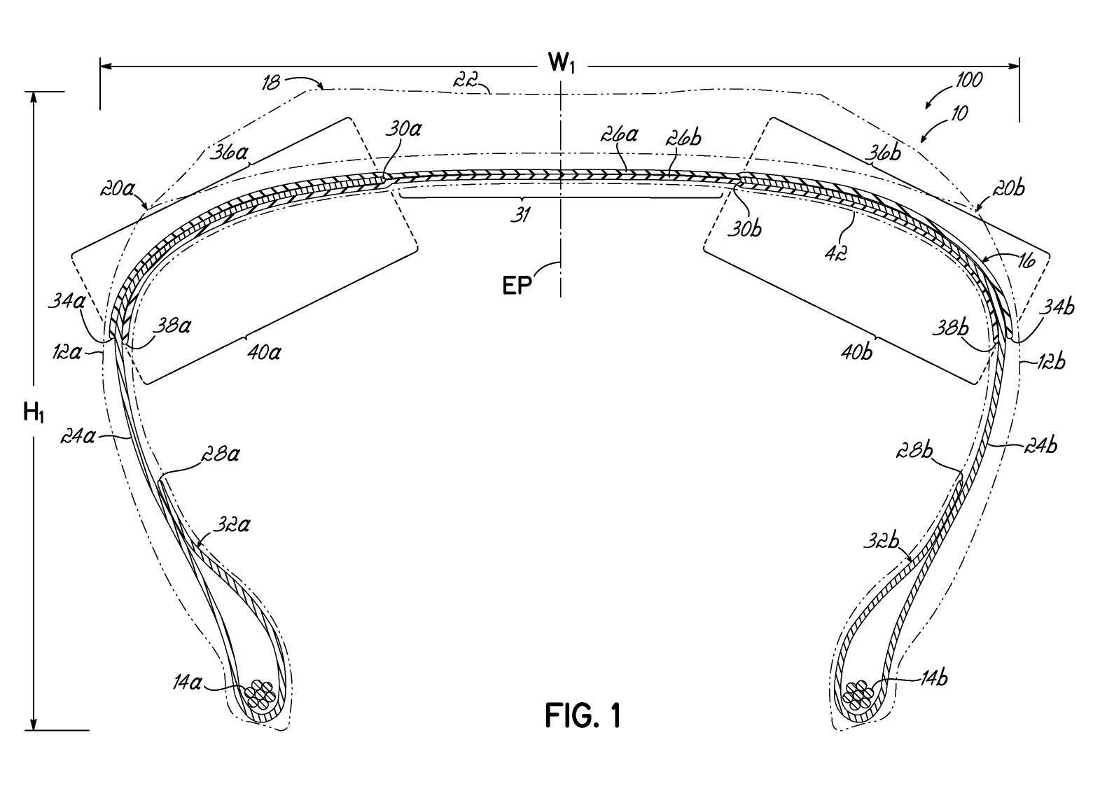

To those and other ends, and with reference to FIG. 1, there is shown a tire 10 that generally includes a sidewall 12a and an opposing sidewall 12b, inextensible beads 14a and 14b, a supporting carcass 16, and a tread 18. The sidewalls 12a, 12b extend radially inward from the axial outer edges of the tread 18 to join the respective inextensible beads 14a, 14b, which are adapted to anchor the tire 10 to a rim (not shown) on a vehicle. Opposing shoulders 20a and 20b of the respective sidewalls 12a and 12b may define the width of the tread 18. The tread 18 includes a running surface 22 for contacting the ground or road surface when the tire 10 is inflated or pressurized for use on the vehicle. The running surface 22 may extend from one shoulder 20a to the other shoulder 20b depending on the configuration of the tire 10. The tire 10 does not include a belt package, as is described in more detail below. Generally, a belt package would be placed between the carcass 16 and the tread 18.

The supporting carcass 16 acts as a supporting structure for the tread 18 during use of the tire 10. To this end, the sidewalls 12a, 12b include multiple separate plies. For example, as shown in FIG. 1, the supporting carcass 16 may include four separate plies. Specifically, the sidewall 12a may include a sidewall ply 24a, the sidewall 12b may include a sidewall ply 24b, and two central plies 26a and 26b may be located adjacent and support the tread 18 during use of the tire 10.

As shown, the sidewall ply 24a has an edge 28a and may extend around the bead 14a with another edge 30a at location proximate the shoulder 20a. The curvilinear distance between the edge 28a and the edge 30a along the sidewall ply 24a in FIG. 1 defines the width of the ply 24a. In addition, the sidewall ply 24a wraps around the bead 14a in an inside-out configuration and forms an inside turn-up 32a. This configuration protects the edge 28a from damaging contact with objects (e.g., curbs) that the tire 10 may encounter during use of the tire 10. It will be appreciated that the inside turn-up 32a improves the durability of the tire 10.

Similarly, the sidewall ply 24b has an edge 28b and may extend around the bead 14b to terminate at a second edge 30b proximate the shoulder 20b. The curvilinear distance between the edge 28b and the edge 30b along the sidewall ply 24b of FIG. 1 defines the width of ply 24b. In one embodiment, as described in more detail below, the widths of the plies 24a and 24b are substantially the same. The sidewall ply 24b wraps around the bead 14b in an inside-out configuration and forms an inside turn-up 32b. As shown, the sidewall ply 24b is separate from and does not overlap the sidewall ply 24a. In the exemplary embodiment shown, the edges 30a, 30b extend to a location between the shoulders 20a, 20b, toward the equatorial plane (EP), and beneath the tread 18. In one embodiment, the sidewall plies 24a, 24b do not extend to the equatorial plane (EP). Rather, the edges 30a, 30b are positioned between the EP and the corresponding nearest shoulder 20a, 20b.

The edges 30a, 30b are thus spaced apart and define a spaced apart region 31 adjacent or beneath the tread 18. By way of example, the spaced apart region 31 may form between about 10% and about 90% of the tread width of a newly constructed tire, and by way of further example, the spaced apart region 31 may form between about 30% and about 70% of the tread width. It will be appreciated, however, that embodiments of the invention are not limited to the particular relative distances shown in FIG. 1. For example, each of the sidewall plies 24a, 24b may extend to a lesser or greater extent toward the EP than the other ply. That is, the spaced apart region 31 may not be symmetrical with the EP.

In addition, the sidewall plies 24a, 24b may extend between the shoulders 20a, 20b and the beads 14a, 14b in other configurations. For example, the inside turn-ups 32a, 32b need not be similar in dimension or in configuration to each other, as one or both may extend to a lesser or a greater distance on the inside of the respective sidewall 12a, 12b than that shown. Moreover, it will also be appreciated that the carcass 16 may include other components not shown in FIG. 1. For example, the carcass 16 may include an inner liner to retain air and improve durability, an apex proximate each bead 14a, 14b, one or more chafers, and/or one or more toe guards. Such additional components may further enhance the tires described herein and tires containing such components are thus within the scope of the present invention.

As set forth above, the carcass 16 includes two central plies 26a and 26b adjacent the tread 18. One or both of central plies 26a, 26b may extend between the corresponding sidewall plies 24a, 24b. That is, at least one of the central plies 26a, 26b may span at least the spaced apart region 31 between the edges 30a, 30b. Thus, the combination of the sidewall plies 24a, 24b and one of the central plies 26a or 26b is sufficient to provide the carcass 16 with at least a single ply thickness extending from the bead 14a to bead 14b.

Furthermore, at least one of the central plies 26a and 26b overlaps the sidewall ply 24a and at least one of the central plies 26a and 26b overlaps the sidewall ply 24b. In this regard, the same central ply may overlap both sidewall plies 24a, 24b or may overlap only a single one of the sidewall plies 24a or 24b with the remaining central ply overlapping the other sidewall ply 24a or 24b. However, for example, as shown in FIG. 1, each of the central plies 26a, 26b may overlap the sidewall ply 24a and the sidewall ply 24b. Specifically, in the exemplary embodiment shown in FIG. 1, the central ply 26a includes an edge 34a proximate the shoulder 20a and an edge 34b proximate the shoulder 20b. The curvilinear distance between the edge 34a and edge 34b along the ply 26a defines the width of the central ply 26a. As shown, the central ply 26a overlaps the sidewall ply 24a by extending past the edge 30a. In the embodiment shown, the central ply 26a also overlaps the sidewall ply 24b by extending past the edge 30b of the sidewall ply 24b. The distance between the edge 30a and the edge 34a and between the edge 30b and the edge 34b forms an overlap region 36a between the sidewall ply 24a and the central ply 26a and forms an overlap region 36b between the sidewall ply 24b and the central ply 26a.

As shown, the overlap regions 36a, 36b are positioned proximate the corresponding shoulder 20a, 20b and may form a substantial portion of the sidewalls 12a, 12b. By way of example, one or both of the overlap regions 36a, 36b may extend toward the corresponding bead 14a, 14b by a distance sufficient to cover up to 90% of the sidewall 12a, 12b, though the overlap regions 36a, 36b are proximate the corresponding shoulder 20a, 20b and may extend at least 10% of the sidewall 12a, 12b. As such, the overlap regions 36a, 36b improve the durability of each sidewall 12a, 12b as the carcass 16 includes at least a double-thick layer of plies at these locations.

In addition or as an alternative thereto, the central ply 26b may extend between the edges 30a and 30b adjacent the tread 18 to cover the spaced apart region 31 between the sidewall plies 24a and 24b. In this regard, the central ply 26b together with the central ply 26a may provide a double thickness of plies beneath the tread 18 in at least the spaced apart region 31. Similar to the central ply 26a, the central ply 26b may have an edge 38a proximate the shoulder 20a such that the central ply 26b may overlap the sidewall ply 24a between the edge 38a of the central ply 26b and the edge 30a of the sidewall ply 24a to form an overlap region 40a. The central ply 26b may also have an edge 38b proximate the shoulder 20b so as to form an overlap region 40b between the edge 38b and the edge 30b. The curvilinear distance between the edge 38a and the edge 38b along the central ply 26b of FIG. 1 defines the width of the ply 26b. In one embodiment, the widths of the plies 26a and 26b are substantially the same. As shown in the embodiment of FIG. 1, the overlap regions 36a, 40a may form a triple thickness of plies proximate the shoulder 20a. A similar triple-thick configuration of regions 36b, 40b may be provided at the shoulder 20b. Advantageously, the carcass 16 is reinforced with plies in the region proximate each shoulder 20a, 20b.

With continued reference to FIG. 1, the relative positions of the central plies 26a, 26b may vary. For example, the central plies 26a, 26b may overlap one or both of the sidewall plies 24a, 24b on the inside only or on the outside only. The overlap region may then reside on the inside only or on the outside only of the corresponding sidewall. In this embodiment, rather than a configuration in which the central plies 26a, 26b sandwich or trap the respective edge 30a and 30b of the sidewall plies 24a and 24b therebetween, as shown, the central plies 26a, 26b may stack on one side or the other of the sidewall plies 24a, 24b.

With regard to the relative dimensions of each of the overlap regions 36a, 36b and 40a, 40b, each may be of different dimension depending on the initial relative size of the respective plies and relative placement of the sidewall plies 24a and 24b and central plies 26a and 26b during the manufacturing process, described below. It will be appreciated that the relative size of the overlap regions 36a, 36b and 40a, 40b may be altered to achieve a particular function or enhance a property of the tire 10 in addition to providing the protective function set out above. In this regard, one or both overlap regions 36a, 40a may extend at least about 5% of the tire's section height (distance from the rim contact location to the tread 18). However, one or both overlap regions 36a, 40a may extend from about 10% to about 90% of the section height. Similarly, one or both of the overlap regions 36b, 40b may extend at least about 5% of the section height or from about 10% to about 90% of the section height. And, by way of further example, the overlap regions 36a and 40a and/or 36b and 40b may vary from about 10% to about 50% of the section height. In any respect, the overlap regions 36a, 36b, 40a, 40b extend a sufficient distance toward the respective bead 14a, 14b to provide enhanced protection to the corresponding sidewall 12a, 12b of the tire 10.

While described in additional detail below, with reference to FIG. 1, each of the sidewall plies 24a and 24b and each of the central plies 26a and 26b include a plurality of cords (not shown in FIG. 1). The orientation of the cords in the respective ply affects the properties of the tire 10. In one embodiment, the cords in each sidewall ply 24a, 24b are radially oriented. That is, the cords are oriented to extend from the corresponding bead 14a, 14b radially outward in the respective sidewall 12a and 12b and are oriented substantially at about 90 degrees with respect to the EP in the carcass 16 adjacent the tread 18.

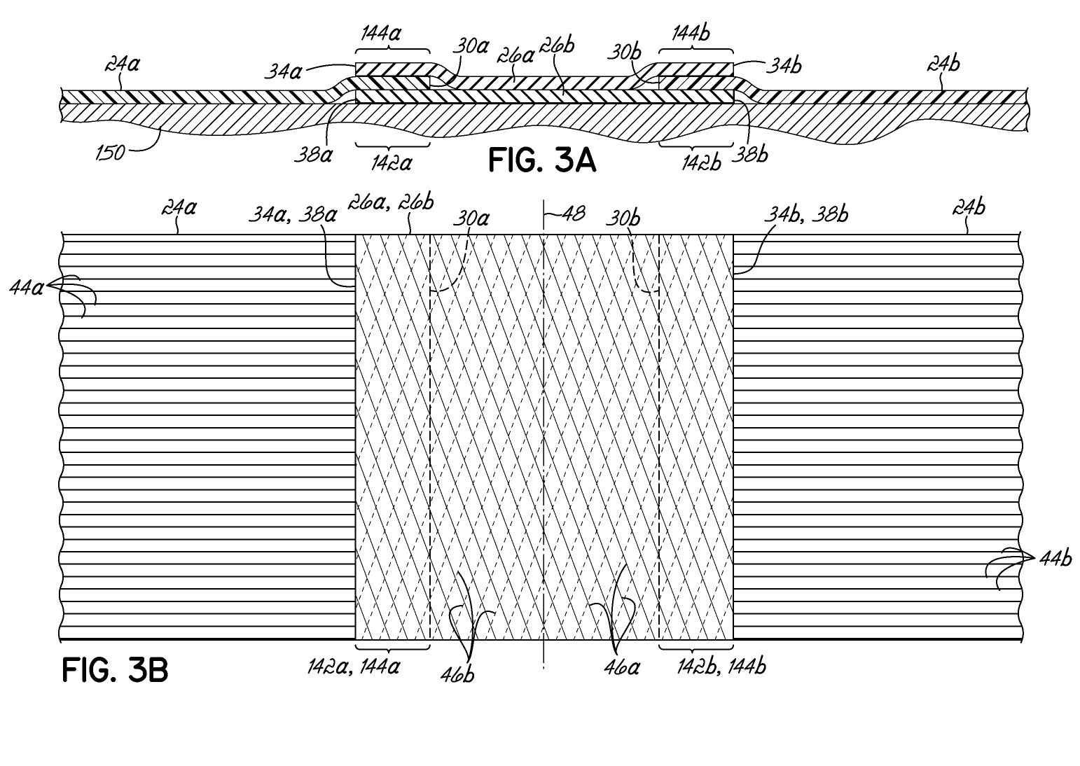

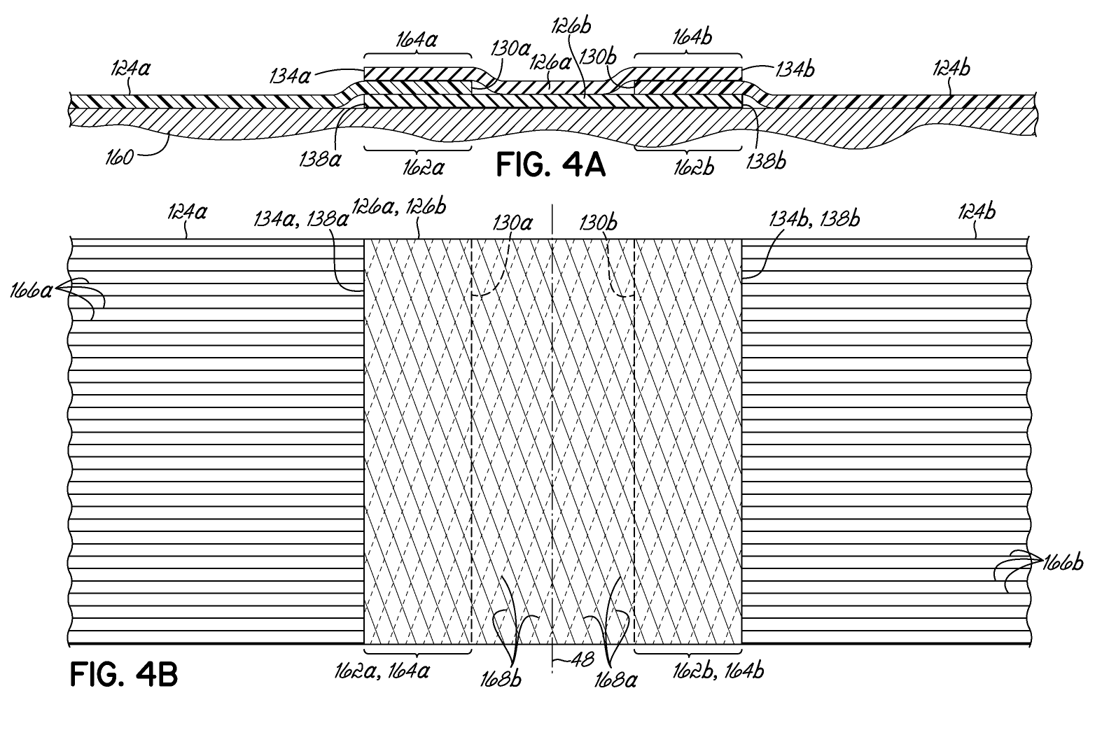

The cords in the central plies 26a, 26b are biased with respect to the EP. In this regard, the cords in one ply are transverse with respect to the EP or criss-cross in the region beneath the tread 18. This is shown in FIGS. 3B and 4B, described below. By way of example, the cords may be oriented from about minus 40 degrees to about 40 degrees with respect to the EP. In one embodiment, the angle between the cords in one of the central plies 26a, 26b and the EP is either about minus 23 degrees or about 23 degrees as shown in FIGS. 3B and 4B. For example, the cords in central ply 26a may be about 23 degrees and the cords in the central ply 26b may be about minus 23 degrees. However, the bias angle may be changed to adjust the ride and/or handling of the vehicle.

In one embodiment, the central plies 26a, 26b collectively replace a steel belt package often used in radial ply tires. The plies 26a, 26b may be adjusted as to both thickness and material type for improved fuel economy, durability, and/or reduction in running temperature. However, the central plies 26a, 26b may not contain steel. The cords may be fibers of one or more of a variety of materials. For example, the cords in each of the sidewall plies 24a, 24b and each of the central plies 26a, 26b may be polyester, aramid, and/or carbon fibers, among others. In this regard, each ply may contain cords of a different material than the other three plies. In addition, the number of cords in each ply may differ according to one embodiment of the invention.

In one embodiment of the invention, a set of tires includes a plurality of tires that differ in at least one of section width and section height, though each of the tires in the set includes at least one ply that is similarly dimensioned and contains the same cord material. For example, a set of tires may include the tire 10, which may be manufactured utilizing a source of plies for any single one of the plies 24a, 24b, 26a, or 26b. A second tire may be manufactured using at least one of the same sources of plies as was used for one of the plies 24a, 24b, 26a, or 26b during the manufacturing of the tire 10.

Regarding tire sizes, a particular tire is made according to industry standard sizes. Standard industry nomenclature is used to indicate tire size. This nomenclature is composed of a series of numbers and letters that are arranged in a predetermined order and may appear on the tire. The series includes information regarding the section width and the aspect ratio, which is a ratio of the section height to section width, of the tire. Generally, the section width is the widest point between the outside surfaces of the sidewalls when the tire is mounted on a rim though the tire is not loaded. The section width is exclusive of any lettering, numbering, or decorative components. The section height is the distance from the rim contact location to outer diameter of the tire at the EP. The section height may be determined from the series by the aspect ratio and the section width. Generally, the larger the section height is, the taller the sidewall of the tire is.

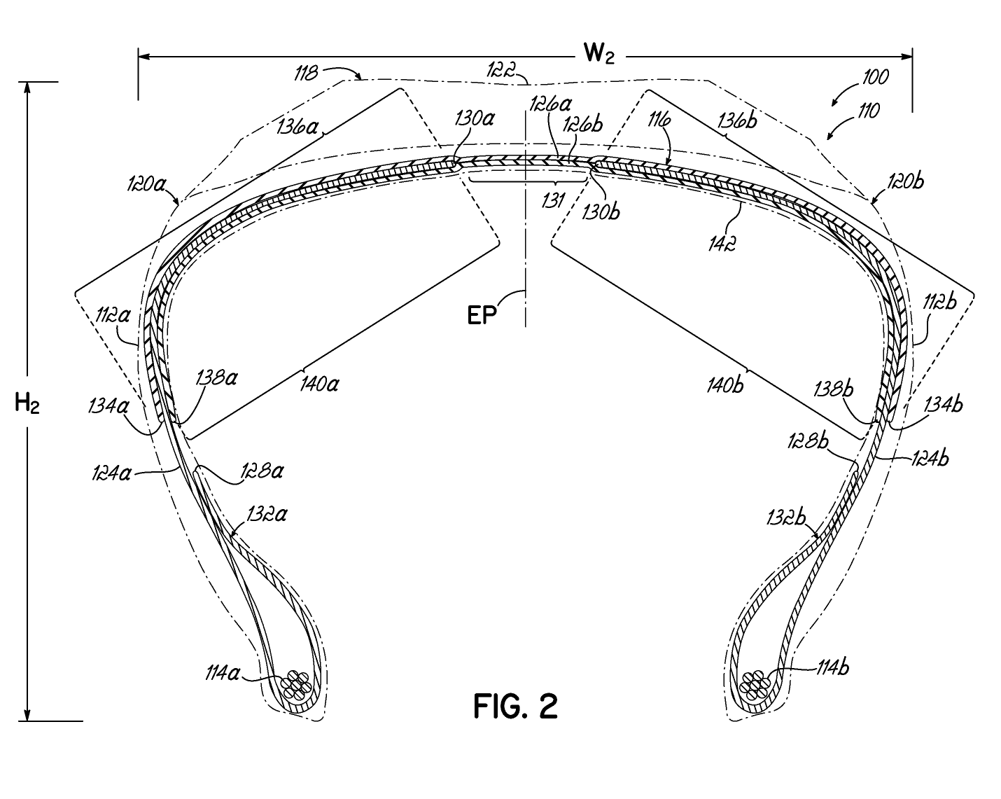

In one embodiment, as introduced above, the set 100 of tires includes the tire 10, shown in FIG. 1, which is characterized by a section width, W1, and a section height, H1. The set 100 of tires includes a second tire, for example, a tire 110 shown in FIG. 2 in which like reference numerals refer to like features in FIG. 1. Tire 110 may be similar to tire 10 in many respects though the tire 110 is characterized by a section width, W2, and a section height, H2. According to embodiments of the present invention, at least one of the section width, W1, and the section height, H1, of tire 10 differ from the respective one of the section width, W2, and the section height, H2 of tire 110. By way of example, in the embodiment shown, the section width W1 is greater than the section width W2 of the tire 110, and the first tire 10 and second tire 110 of the set 100 of tires have substantially the same section height. That is, section height H1 is approximately the same as the section height H2. However, as will be appreciated based on the description of the set 100 of tires set out below, both the section height and the section width of the first tire 10 and the second tire 110 may differ according to one embodiment of the invention.

More specifically, a difference in at least one of the section height and the section width of the tires 10, 110, may be achieved according to one embodiment of the invention. To that end, the tire 110 includes opposing sidewalls 112a, 112b, inextensible beads 114a and 114b, a supporting carcass 116, and a tread 118. The sidewalls 112a, 112b extend radially inward from the tread 118 to join the respective inextensible beads 114a and 114b. Opposing shoulders 120a and 120b of the sidewalls 112a and 112b define the width of the tread 118. The tread 118 includes a running surface 122. All of which have similar functions to the functions of the corresponding component of tire 10, shown in FIG. 1.

Furthermore, the supporting carcass 116 of the tire 110 includes multiple separate plies. For example, as shown in FIG. 2, the supporting carcass 116 may include four separate plies. In this regard, the sidewall 112a may include a sidewall ply 124a, the sidewall 112b may include a sidewall ply 124b, and two central plies 126a and 126b may be located adjacent and support the tread 118 during use. In one embodiment, at least one of the plies 124a, 124b, 126a, or 126b is obtained from the same source of plies from which the sidewall ply 24a, the sidewall ply 24b, the central ply 26a, or the central ply 26b is supplied, as set out above and shown in FIG. 1. While described in more detail below, the tire 110 has at least one ply of similar dimension (e.g. width) and of the same cord material as one of the plies 24a, 24b, 26a, or 26b in the tire 10.

The arrangement of the plies 124a, 124b, 126a, 126b relative to one another may be similar to the tire 10 depicted in FIG. 1. In this regard, the sidewall ply 124a has an edge 128a and may extend around the bead 114a with another edge 130a at a location proximate the shoulder 120a. The curvilinear distance between the edge 128a and the edge 130a along the ply 24a defines the width of the ply 124a. In one embodiment, the width of ply 124a is substantially the same as the width of ply 24a of tire 10. The sidewall ply 124a wraps around the bead 114a in an inside-out configuration and forms an inside turn-up 132a. The sidewall ply 124b, being similarly arranged, forms an inside turn-up 132b with the edge 128b on the inside of the tire 110 with the other edge 130b proximate the shoulder 120b.

Similar to plies 26a and 26b, the central plies 126a and 126b span a spaced apart region 131 between the edges 130a and 130b of the sidewalls plies 124a, 124b and provide a double thick layer of plies adjacent the tread 118. The central plies 126a and 126b also overlap each of the sidewall plies 124a, 124b with one edge 134a, 138a terminating proximate the shoulder 120a and another edge 134b, 138b terminating proximate the shoulder 120b. The curvilinear distance between edges 134a and 134b and between edges 138a and 138b along the corresponding central plies 126a and 126b define the respective width of plies 126a and 126b. In one embodiment, the widths of the plies 126a and 126b are substantially the same and are substantially the same as the widths of plies 26a and 26b of the tire 10 shown in FIG. 1. However, it will be appreciated that the plies 126a and 126b need not be similar in width and that neither of the plies 126a and 126b may be the same width as the plies 26a or 26b, as long as one ply of the tire 110 is from the same source of plies for manufacturing the tire 10.

Overlap regions 136a and 140a are formed proximate the shoulder 120a, and overlap regions 136b and 140b are formed proximate the shoulder 120b. As shown, the overlap regions 136a and 140a are similarly positioned with respect to each other, as are the overlap regions 136b and 140b. However, it will be appreciated that the invention is not so limited, as there may be no need to place the overlapping regions 136a and 140a and 136b and 140b in coinciding locations proximate the corresponding shoulder 120a, 120b. In this regard, the relative positions of the overlapping regions 136a, 136b, 140a and 140b may depend on the width of the respective ply and its placement during tire manufacturing, as described below.

However, at least one of the overlap regions 136a and 140a and 136b and 140b of the tire 110 shown in FIG. 2 differ in dimension from the corresponding overlap regions 36a and 40a and 36b and 40b of the tire 10 shown in FIG. 1. For example, at least one of the overlap regions 136a and 140a and 136b and 140b may be larger than the corresponding overlap regions in the tire 10. The larger dimension of the at least one overlap region in the tire 110 is related to the smaller relative section width, W2, of the tire 110. For example, where the overlap region 136a is increased by about 10%, the section width W2 may be reduced by a percentage directly related or proportional to the 10% increase, for example, about 10%. It will be appreciated that the total reduction in the section width W2 may depend on other factors in addition to the increase in the overlap region 136a. For example, each of the sidewall 112a and 112b may be different in thickness when compared to the sidewall 12a and 12b. In this case, the section width W2 may not be reduced by a full 10% though the distance from the sidewall ply 124a from edge 130a to the EP may be reduced by an amount directly related to the 10% increase in the overlap region 136a.

Furthermore, it will be appreciated that increasing, or reducing, the overlap regions 136a and 140a and/or 136b and 140b relative to those of tire 10 may change the characteristics of the tire 110. In particular, for an increase in the overlap region dimensions, the tire 110 may exhibit further improved durability when exposed to road debris. That is, the increase in size of the overlap regions 136a and 140a and/or 136b and 140b may extend the region toward the respective bead 114a, 114b and form a larger portion of the respective sidewall 112a, 112b. Thus, the relative increase in the overlap may improve the resistance of the tire 10 to puncture during operation relative to the overlap regions 36a and 40a and/or 36b and 40b in tire 10. In addition, the overlap regions 136a and 140a and/or 136b and 140b may increase the stiffness of the tire 110 relative to the tire 10, particularly in the sidewalls 112a and 112b.

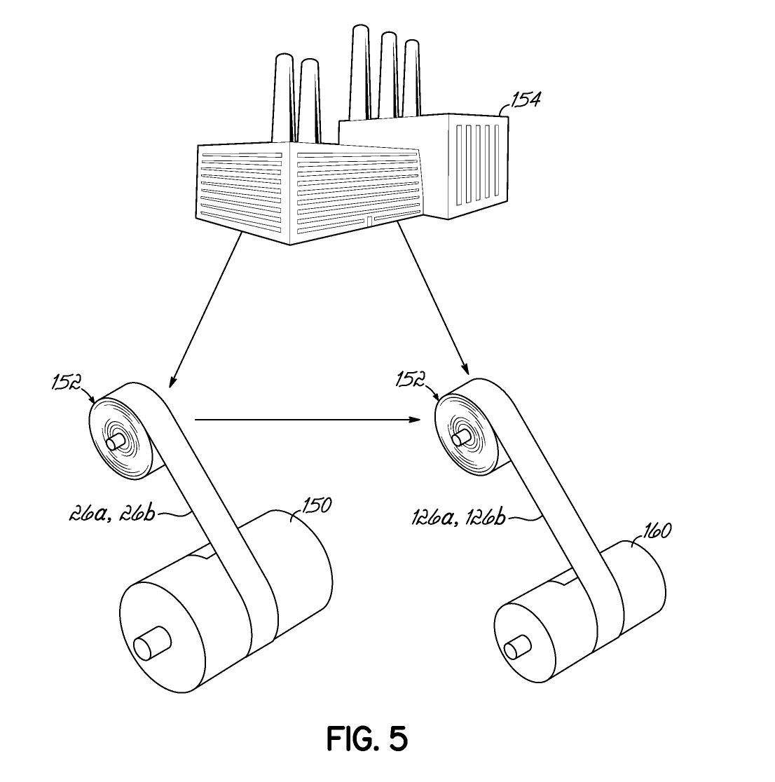

According to another embodiment of the present invention, a method is provided for manufacturing a set 100 of tires including at least two tires differing in section width and/or section height. The difference in section height and/or section width is achieved by changing the overlap between some or all of the plies during the building process. For example, one of the tires of the set 100 may include the tire 10, shown in FIG. 1. With reference to FIGS. 3A, 3B and 5, the method may generally include building or layering a set of four plies, for example, the plies 24a, 24b, 26a, and 26b, to a building drum 150. As is known, the building drum 150 may be outwardly expandable. As shown in FIG. 5, the central ply 26b may be supplied from a source 154 of plies. The source 154 may include an inventory of plies in a stockroom at a manufacturing facility from which the plies may be taken as they are used in the manufacturing process. The inventory may include the individual plies or a roll or spool 152 of ply material, in which case the ply material is cut to length once it is wound around the drum 150.

The central ply 26b may be applied to the drum 150 first from the spindle 152. However, the central ply 26b may be applied to the drum 150 after the sidewall plies 24a and 24b. Once applied to the drum 150, the sidewall plies 24a and 24b may then be folded over respective beads (not shown) in such a manner as to overlap the central ply 26b and space the edges 30a and 30b of each of the sidewall plies 24a and 24b apart from one another. The central ply 26a is then applied from the spindle 152, when it is determined that the width and cord material for the central ply 26a is to be the same as the width and cord material for the central ply 26b, or from another spindle of ply material to overlap each of the sidewall plies 24a and 24b and central ply 26b. As shown in FIG. 3A, the central plies 26a and 26b may essentially “sandwich” portions of the sidewall plies 24a and 24b and the corresponding edges 30a and 30b thereof between them.

As set forth above, the plies 24a, 24b, 26a, and 26b include a plurality of cords. With reference to FIG. 3B, the ply 24a may include a plurality of cords 44a, ply 24b may include a plurality of cords 44b, ply 26a may include a plurality of cords 46a, and ply 26b may include a plurality of cords 46b. An exemplary orientation of the respective cords is illustrated in FIG. 3B. Generally, the cords 44a, 44b are oriented substantially perpendicular to an axis 48 so as to form radially oriented cords in tire 10. The cords 46a, 46b may be oriented at an angle that is transverse to the axis 48. By way of example, the angle may be between about minus 50 degrees to about 50 degrees, and by way of additional example, the angle may be between about minus 30 degrees to about 30 degrees with respect to the axis 48.

As indicated above, during application of the plies 24a and 24b and central ply 26b to the drum 150, areas of overlap between the adjacent plies are created. For example, areas of overlap 142a and 142b may be formed between the sidewall plies 24a and 24b and the central ply 26b. The area of overlap 142a is generally determined by the distance between the edge 30a of the ply 24a and the edge 38a of the central ply 26b with direct contact between the sidewall ply 24a and the central ply 26b between the two edges 30a and 38a defining the area of overlap 142a. Similarly, the area of overlap 142b may be defined by the distance between the edges 30b and 38b and the contact between the central ply 26b and the sidewall ply 24b. These areas may generally correspond, or at least be related, to the dimensions of the overlap regions 40a and 40b, shown in FIG. 1, as is described in more detail below.

Additional areas of overlap may include areas 144a and 144b between the central ply 26a and the sidewall plies 24a and 24b. As with areas of overlap 142a and 142b, set out above, the areas of overlap 144a and 144b may each be determined by the distance between the respective edges 30a, 30b of the sidewall plies 24a, 24b and the edges 34a, 34b of the central ply 26a. These areas may generally correspond or at least be related to the dimensions of the overlap regions 36a and 36b. It will be appreciated that numerous other components may be applied to the drum 150 before, during, or after application of the plies 24a, 24b, 26a, and 26b to the building drum 150 though these additional components are not shown. For example, chafers, a liner, a pair of beads, and a tread to name only a few, may be included during the building process described above.

The manufacturing process further includes additional processes by which a tire is manufactured from the set of plies and the other components, as set out above or in an alternative method known in the art. By way of example, the drum 150 may be expanded to cause the above assembly of plies to form a generally toroidal shape (not shown). Additional components may then be added to the toroidal shape to form a green tire. By way of example, additional components may include a tread (not shown). However, as set forth above, no belt packages are included in the green tire. The green tire is subsequently cured in a mold under heat and pressure to form the tire 10. It will be appreciated that there are alternative processes for manufacturing a tire, other than that explicitly described herein. The general description of manufacturing given is thus in no way limiting to the application of the plies described herein. That is, building or layering the plies as described herein may be used in alternative tire building processes known in the art.

Advantageously, the overlapping configuration of the plies 24a, 24b, 26a, and 26b may aid manufacturing of the tire 10, particularly during process development for a new tire. In this regard, the time to develop and costs to bring a new tire design to commercial production may be reduced by utilizing the separate plies 24a, 24b, 26a, and 26b. For example, during curing, the plies 24a and 24b may move relative to the central plies 26a and 26b. This relative movement may change the areas of overlap 142a, 142b and 144a, 144b from the dimensions obtained when the plies 24a, 24b, 26a, and 26b were assembled on the drum 150. A change in dimension of the areas of overlap 142a, 142b and/or 144a, 144b may include relative movement between the edge 30a and the edges 34a, 38a and/or between the edge 30b and the edges 34b, 38b. The corresponding edges may move more closely together or further apart. Consequently, the corresponding overlap regions 36a, 36b, 40a, and 40b in the tire 10 may differ in dimension than the areas of overlap 142a, 142b and 144a, 144b formed during building of the tire by application of the plies 24a, 24b, 26a, and 26b to the drum 150.

Relative movement of the plies 24a, 24b, 26a, and 26b may be beneficial to the tire manufacturing process. In particular, relative movement may reduce the amount of experimentation required to achieve a desired or targeted tire design. This may be further explained by contrast to a green tire which includes a single ply that extends continuously from one bead to the opposing bead. In this situation, the beads hold the ply in position during curing. If the distance between the beads is too close or too far apart, the ply may be too tight or too loose during subsequent curing. As a result, the cured tire may not meet the required quality standards. The building process or design may then require an adjustment to tune the ply tension toward the desired value. Adjustments may include changing the dimension of the ply, such as, the ply width or the gage of the ply. Moreover, many adjustments may be required before the desired ply tension in the tire is realized. According to embodiments of the invention, however, rather than iteratively tuning a single, continuous ply, the overlap areas 142a, 142b and 144a, 144b allow the plies 24a, 24b, 26a, and 26b to self-adjust or float to a natural tension that is determined by the curing mold and the associated pressures and temperature. Thus, as long as there is sufficient overlap of the plies 24a, 24b, 26a, and 26b, they require little, if any, tension adjustment with respect to the ply dimensions, and a drawn out, iterative trial-and-error approach and the costs associated therewith are avoided.

In addition, according to one embodiment of the invention, manufacturing the set 100 of tires includes manufacturing a second tire that differs from the tire 10 in at least one dimension, such as, section width or section height. For example, manufacturing the second tire may include manufacturing the tire 110, shown in FIG. 2. As set out above, the tire 110 is generally narrower in width than the tire 10. Specifically, the section width W2 of the tire 110 may be smaller than the section width W1 of tire 10.

To this end and with reference to FIGS. 2, 4A, 4B, and 5, manufacturing the tire 110 may include building or layering a set of four plies similar to that of tire 10, by applying the central ply 126b on an expandable building drum 160. It will be appreciated that a set of three plies may be also be used such that a single central ply is applied rather than two central plies. As shown in FIG. 5, the central ply 126b may be supplied from another spindle 152 from the same source 154 of spindles for supplying the central ply 26b during building of the tire 10. In this exemplary embodiment, the width of the central ply 126b is substantially the same as the width of the central ply 26b though the length of the plies 26b and 126b may differ as required by the diameter of the corresponding tire.

The sidewall plies 124a, 124b for tire 110 may then be applied to the drum 160 and folded so as to overlap the central ply 126b. The sidewall plies 124a and/or 124b may be from the same source 154 of ply material or a different source as the sidewall plies 24a and 24b. In the exemplary embodiment shown, each sidewall ply 24a, 24b, 124a, and 124b has the same width and cord material and thus may be supplied from the same source 154 of ply material.

Similar to the building process of tire 10 described above, areas of overlap 162a and 162b may be formed between the sidewall plies 124a and 124b and the central ply 126b. These areas may generally correspond or at least be related to the dimensions of the overlap regions 140a and 140b, shown in FIG. 2. Additional areas of overlap may include areas 164a and 164b between the central ply 126a and the sidewall plies 124a and 124b. These areas may generally correspond or at least be related to the dimensions of the overlap regions 136a and 136b. Generally, to achieve a reduction in the section width W2 (FIG. 2) relative to the section width W1 (FIG. 1), at least one of the areas of overlap 162a and 164a and/or 162b and 164b for the tire 110 will be greater than the corresponding areas of overlap 142a and 144a and/or 142b and 144b for the tire 10. It will be appreciated that numerous other components may be applied to the drum 160 before, during, or after application of the plies 124a, 124b, 126a, and 126b to the building drum 160, as set out above, though these additional components are not shown. Each of the plies 124a, 124b, 126a, and 126b may contain cords similar to those set forth above with regard to FIG. 3B. For example, the plies 124a and 124b may contain a plurality of cords 166a and 166b, respectively, which may be the same or of a different material, and the plies 126a and 126b may contain a plurality of cords 166a and 166b, respectively. The orientation of the cords may be similar to that shown in FIG. 3B.

The manufacturing process further includes additional processes by which a tire is manufactured from the plies 124a, 124b, 126a, and 126b as set out above. By way of example, the drum 160 may be expanded to form a generally toroidal shape (not shown). Additional components may then be added to the toroidal shape to form a green tire (not shown). By way of example, additional components may include a tread (not shown). The green tire is subsequently molded under heat and pressure to cure the green tire and to form the tire 110.

As shown, the section width of the tire 110 differs from the tire 10 though the dimension (e.g. width) of at least one of the plies 24a, 24b, 26a, 26b of tire 10 is similar to the plies 124a, 124b, 126a, and 126b of tires 110. The difference in section width is achieved by variation in the dimension of the areas of overlap 162a and 162b and 164a and 164b relative to one or more of the areas of overlap 142a, 142b and/or 144a, 144b. In particular, a smaller relative section width may be achieved by increasing in the areas of overlap 162a and 164a and/or 162b and 164b during assembly of the plies 124a, 124b, 126a, 126b. It will be appreciated that the dimensions of each of the areas of overlap 162a, 162b, 164a, and 164b may be changed to reduce the section width of the tire 110 relative to that of the tire 10. For example, the dimensions of each areas of overlap 162a, 162b, 164a and 164b may be reduced by an equivalent amount or in a manner that is symmetrical relative to the EP. However, it will be appreciated that embodiments of the invention are not limited to symmetrical configurations as only a single pair of 162a and 164a or 162b and 164b may be changed to reduce the section width of the tire 110 relative to the tire 10. Such a configuration may therefore be asymmetrical relative to the EP. In addition, though not shown, the section height in addition, or as an alternative, to the section width may be changed by further modification of the dimensions of the areas of overlap 162a, 162b, 164a, and/or 164b during the building process.

In one embodiment, the set 100 of tires is manufactured from a single source of plies for both plies 24a, 24b and 124a, 124b and a single source of plies for plies 26a, 26b and plies 126a and 126b. In this regard, at least two tires are manufactured during which areas of overlap 162a and 162b and/or 164a and 164b differ in dimension from areas of overlap 142a and 142b and/or 144a and 144b such that at least one of the section width or section height as between the tires in the set 100 is different. However, as set forth above, it will be appreciated that each of the plies 24a and 24b may be supplied from different sources. Similarly, each of the plies 26a and 26b may be supplied from different sources. This may occur where each ply contains a different cord material. In this manner, the tire 10 may include different cord material in each of the plies 24a, 24b, 26a, 26b. A total of four separate sources of plies may therefore be used to manufacture each tire. However, at least one of the same source of plies for tire 10 is used to supply a corresponding ply during the manufacturing of another tire. For example, the same four sources of plies may supply other tire production lines although the other lines produce different sized tires. In view of the above, the set 100 of tires may include a range of tire sizes each having different section widths and/or section heights though they share at least one source of plies.

Embodiments of the invention advantageously reduce the costs associated with manufacturing tires generally because a single source of plies may supply multiple tire building processes. In other words, the tire 10 may be built on one production line while the tire 110 may be built on another production line with both production lines using the same source of plies for at least one of plies 24a, 24b, 26a, 26b, 124a, 124b, 126a, and/or 126b. It will be appreciated, that tires 10, 110 may be manufactured at the same time or at different times using the same source of plies. Reducing the inventory of different sized plies reduces cost associated with maintaining a large inventory of different sized plies and eliminates waste associated with excess material.

While the present invention has been illustrated by the description of one or more embodiments thereof, and while the embodiments have been described in considerable detail, they are not intended to restrict or in any way limit the scope of the appended claims to such detail. Additional advantage and modifications will readily appear to those skilled in the art. The invention in its broader aspects is therefore not limited to the specific details, representative methods and illustrative examples shown and described. Accordingly, departures may be made from such details without departing from the scope or spirit of Applicants' general inventive concept.

What is claimed is:

1. A pneumatic tire for use on a vehicle, the tire comprising:
a first bead and a second bead each configured to anchor the tire to a rim of the vehicle;
a pair of opposing sidewalls forming opposing shoulders and extending radially inward from a tread;
a first ply forming a portion of one sidewall, the first ply extending from one shoulder around the first bead from outside to inside, so as to form a first inside turn-up;
a second ply separate from the first ply and forming a portion of the opposing sidewall, the second ply extending from the opposing shoulder around the second bead from outside to inside, so as to form a second inside turn-up;
a first central ply adjacent the tread and extending between and overlapping the first ply and the second ply; and
a second central ply adjacent the tread and the first central ply and extending between and overlapping the first ply and the second ply,
wherein the overlap of the first central ply with each of the first and second plies forms a first overlap region separated from a second overlap region, respectively, the first overlap region being proximate the one shoulder and the second overlap region being proximate the opposing shoulder, each of the first and second overlap regions being sized to protect the tire from penetration by road debris during use of the tire.

2. The pneumatic tire of claim 1, wherein an edge of each of the first ply and the second ply is positioned between the first central ply and the second central ply.

3. The pneumatic tire of claim 1, wherein each of the first and second central plies includes a plurality of cords and an angle between the cords of the first central ply and the cords of the second central ply is between about 40 degrees and about 50 degrees.

4. The pneumatic tire of claim 1, wherein the tire is belt-less.

5. The pneumatic tire of claim 1, wherein each of the first and second plies and the first and second central plies includes a plurality of cords and the material of the cords of at least one of the first central ply and the second central ply is different from the material of the cords of at least one of the first ply and the second ply.

6. The pneumatic tire of claim 5, wherein the cords of at least one of the first central ply and second central ply is at least one of carbon fibers, or aramid fibers, or combinations thereof.

7. A tire set comprising:
a first tire having a first section width and a first section height, and
a second tire having a second section width and a second height, at least one of the first section width and the first section height differing from the corresponding one of the second section width and the second section height, each of the first tire and the second tire including a pair of opposing sidewalls forming opposing shoulders and extending radially inward from a tread and a pair of beads configured to anchor the respective tire to a rim on a vehicle,
each of the first tire and the second tire comprising:
a sidewall ply forming a portion of each sidewall of the pair of sidewalls and defining an inside turn-up at one edge thereof with an opposing edge extending to a location proximate the corresponding shoulder; and
a central ply positioned adjacent each tread and extending between and overlapping the corresponding sidewall plies so as to form at least two overlap regions, one overlap region proximate each shoulder of each tire, each of the sidewall plies and the central ply in the first tire being substantially the same width as each of the corresponding sidewall plies and the corresponding central ply in the second tire,
wherein at least one of the overlap regions in the first tire is substantially different in dimension from one of the overlap regions in the second tire, the difference in dimension being related to the difference between the first section width and the second section width and/or the first section height and the second section height.

8. The tire set of claim 7, the overlap regions in each tire are proximate the corresponding tread shoulder and are sized to protect the corresponding tire from penetration by road debris during use.

9. The tire set of claim 7, wherein the stiffness of the first tire in one of the shoulders is different than the stiffness of the second tire in one of the shoulders.

10. The tire set of claim 7, wherein the first tire and the second tire are belt-less.

11. The tire set of claim 7, wherein at least one of the first tire and the second tire comprises a second central ply.

12. A method of making tires of different section width and/or section height comprising:
manufacturing a first tire comprising:
applying a first set of plies to a first building drum, one ply being configured to form portions of each of a pair of opposing sidewall plies and at least one ply being configured to be adjacent a tread in the first tire, wherein the opposing sidewall plies do not overlap and are spaced apart from each other on the first building drum and the at least one ply extends between and overlaps each of the sidewall plies; and
manufacturing a second tire comprising:
applying a second set of plies to a second building drum, at least one of the plies of the second set of plies being from a source of plies used for supplying at least one of the plies of the first set of plies during manufacturing of the first tire, one ply of the second set of plies being configured to form a portion of each of a pair of opposing sidewall plies and at least one ply being configured to be adjacent a tread in the second tire, wherein the opposing sidewall plies of the second set of plies do not overlap and are spaced apart from each other on the second building drum and the at least one ply extends between and overlaps each sidewall ply,
wherein the first tire differs in dimension from the second tire in at least one of section width or section height.

13. The method of claim 12, wherein, in the first tire, the overlap between the sidewall plies and the at least one ply forms a first overlap region spaced apart from a second overlap region, and, in the second tire, the overlap between the sidewall plies and the at least one ply forms a third overlap region spaced apart from a fourth overlap region, and wherein one of the first overlap region and the second overlap region differ in dimension from at least one of the third overlap region and the fourth overlap region, the difference in dimension being related to the difference in at least one of the section width and the section height between the first tire and the second tire.

14. The method of claim 13, wherein each of the first and the second overlap regions differ in dimension from the third and fourth overlap regions, the difference in dimension being directly attributable to the difference in dimension of the tires.

15. The method of claim 12, wherein manufacturing the first tire further comprises:
providing a source of sidewall plies and providing a source of central plies, and
manufacturing the second tire further comprises supplying the opposing sidewall plies from the source of sidewall plies or supplying the at least one ply from the source of central plies.

16. The method of claim 12, wherein applying the at least one ply configured to be adjacent a tread in one of the first or second tires includes applying a pair of central plies configured to be adjacent the tread.

17. The method of claim 16, wherein applying the pair of central plies of the first tire or applying the pair of central plies of the second tire includes (i) applying a first central ply including a plurality of cords to the corresponding building drum so that the cords are configured to be transverse to an equatorial plane of the corresponding tire and (ii) applying a second central ply including a plurality of cords so that the cords are configured to be transverse to the equatorial plane of the corresponding tire and transverse to the cords of the first central ply.

18. A set of tires made according to the method of claim 12.
